(19) United States
(12) Patent Application Publication
(10) Pub. No.: US 2004/0048495 A1
(43) Pub. Date: Mar. 11, 2004

(54) Pick up cap for an electrical socket

(76) Inventors: JinFeng Lei, Kun san (CN); Ren-Chih Li, Tu-chen (TW); Yuang-Lung Zang, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/339,870

(22) Filed: Jan. 9, 2003

(30) Foreign Application Priority Data
Sep. 11, 2002 (TW) 91214230

(51) Int. Cl. H01R 13/60

(52) U.S. Cl. 439/41

(57) ABSTRACT

A CPU socket assembly comprises a CPU socket and a pick up cap to be vertically attached to the CPU socket. The cover defines a square opening surrounded by four inner side edges and four recesses defined at junctions of a bottom face of the cover and the four side edges respectively. The pick up cap includes a base defined a smooth and integral top surface and an opposite bottom surface. Four blocks are formed on the bottom surface corresponding to the recesses of the cover. Each block forms a latch protrusion at a longitudinal edge thereof distal from the bottom surface. In assembly, the latch protrusions of the pick up cap engage in the recesses of the inner side edges of the cover.

### BACKGROUND OF THE INVENTION

1. Field of the Invention

The present invention relates to an electrical socket, and particularly to a pick up cap of the electrical socket used for manipulating the electrical socket onto an electronic device where the socket is seated.

2. Description of the Prior Art

Electronic components, such as CPU (Central Processing Unit) sockets, are often appropriately positioned on a printed circuit board (PCB) like a motherboard by means of a vacuum suction device. Since the cover of the CPU socket has a plurality of through holes in the substantial entire surface thereof, a pick up cap of the CPU socket has to be attached on edges or side areas of the CPU socket and the vacuum suction device is then able to engage on a top flat surface of the pick up cap so as to properly move and position the CPU socket onto the PCB. Such a pick up cap is disclosed in U.S. Pat. No. 6,413,111. Referring to FIGS. 6 through 8, a conventional CPU socket assembly comprises a CPU socket 8 and a pick up cap 9 to be vertically attached to the CPU socket 8. The CPU socket 8 has a housing 83 retaining a plurality of terminals, and a slidable cover 81 covering the housing 83. The cover 81 defines a square opening 82 and several recesses 822 defined at inner side edges 821 of the opening and communicating with the square opening 82 near a bottom inner surface of the cover 81. The pick up cap 9 is vertically assembled with the cover 81 during the process of the CPU socket 8 being arranged onto the PCB. The pick up cap 9 forms on a bottom surface thereof an embossment 94, and a pair of latching arms 93 opposite to the embossment 94. Corresponding to the embossment 94 and each latching arm 93, the pick up cap 9 defines a plurality of slots 92 extending vertically therethrough. Referring particularly to FIG. 8, the embossment 94 is firstly inserted into a corresponding recess 822 of the cover 81, and the latching arms 93 are then latched within the other corresponding recesses 822 of the cover 81, thereby attaching the pick up cap 9 to the cover 81. Thus, the CPU socket assembly is appropriately positioned on the PCB by using a vacuum suction nozzle (not shown) to suck the top surface 91 of the pick up cap 9 and move both the cap and socket to an appropriate place on the PCB.

In the molding process of the pick up cap 9, the latching distal ends of the embossment 94 and latching arms 93 are formed by means of some pins extending through the slots 92 of the cap 9 from the mold. Therefore, the slots 92 are necessarily defined. However, any blemish like a gap or a recess in the surface of a pick-up cap is likely to diminish steady and reliable sucking of the pick-up cap by the vacuum suction nozzle. In particular, the cap 9 having the slots 92 in its top surface is likely to adversely affect reliable sucking of the top surface 91 of the cap 9 by the vacuum suction nozzle, because of air leakage from slots 92 of the pick up cap 9.

In view of the above, a new pick up cap for an electrical socket that overcomes the above-mentioned disadvantages is desired.

### SUMMARY OF THE INVENTION

Accordingly, an object of the present invention is to provide a pick up cap for a CPU socket which can be effectively and reliably lifted up by a vacuum suction nozzle during the process of assembling the CPU socket with a PCB.

To achieve the above-mentioned object, a CPU socket assembly in accordance with a preferred embodiment of the present invention comprises a CPU socket and a pick up cap to be vertically attached to the CPU-socket. The cover defines a square opening surrounded by four inner side edges and four recesses defined at junctions of a bottom face of the cover and the four side edges respectively. The pick up cap includes a base defined a smooth and integral top surface and an opposite bottom surface. Four blocks are formed on the bottom surface corresponding to the recesses of the cover. Each block forms a latch protrusion at a longitudinal edge thereof distal from the bottom surface. In assembly, the latch protrusions of the pick up cap engage in the recesses of the inner side edges of the cover.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a CPU socket assembly in accordance with a preferred embodiment of the present invention, the CPU socket assembly comprising a pick up cap and a CPU socket, the CPU socket comprising a base and a cover;

FIG. 2 is an enlarged, isometric view of the pick up cap of FIG. 1, showing the pick up cap inverted;

FIG. 3 is an assembled view of FIG. 1;

FIG. 4 is an enlarged, isometric view of the pick up cap and the cover of FIG. 1 attached together and inverted, with parts thereof cut away for clearer illustration;

FIG. 5 is an enlarged view of a circled portion V of FIG. 4;

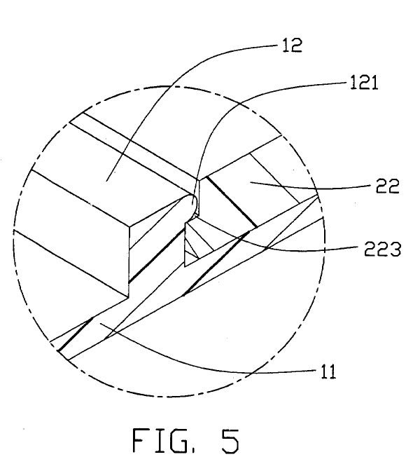

FIG. 6 is an exploded isometric view of a conventional CPU socket assembly, the CPU socket assembly comprising a pick up cap and a CPU socket, the CPU socket comprising a base and a cover;

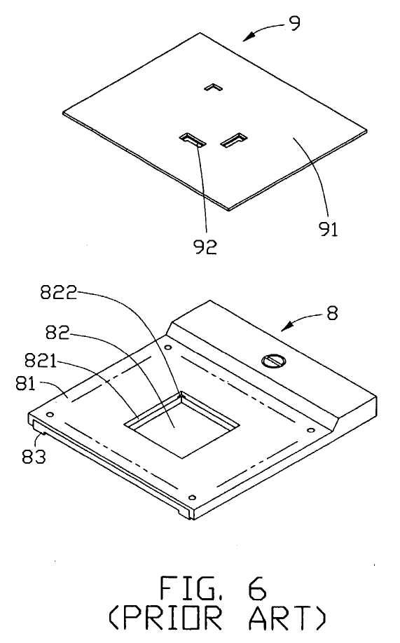

FIG. 7 is an enlarged, isometric view of the pick up cap of FIG. 6, showing the pick up cap inverted; and

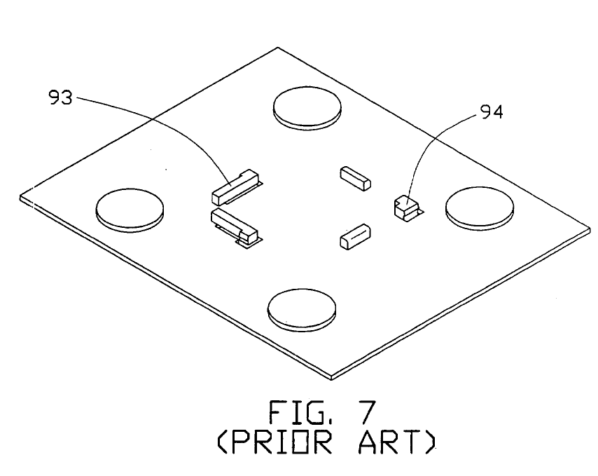

FIG. 8 is an enlarged, isometric view of the pick up cap and the cover of FIG. 6 attached together and inverted.

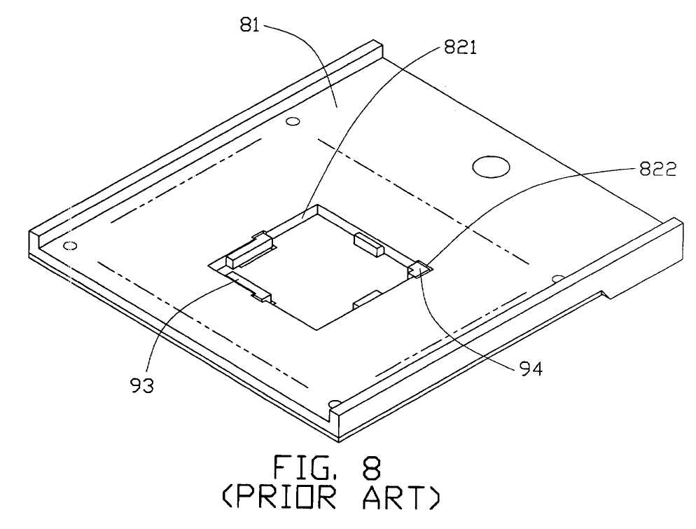

### DETAILED DESCRIPTION OF THE PREFERRED EMBODIMENT OF THE INVENTION

Reference will now be made to the drawings to describe the present invention in detail.

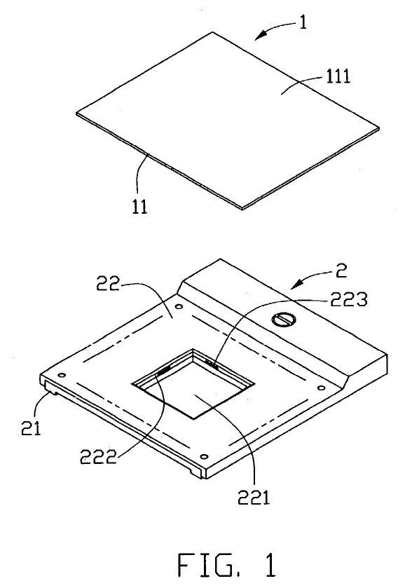

Referring to FIG. 1, a CPU socket assembly in accordance with the present invention comprises a CPU socket 2 and a pick up cap 1. The pick up cap 1 is vertically fastened onto the CPU socket 2 during processes of assembling the CPU socket 2 with a printed circuit board (not shown).

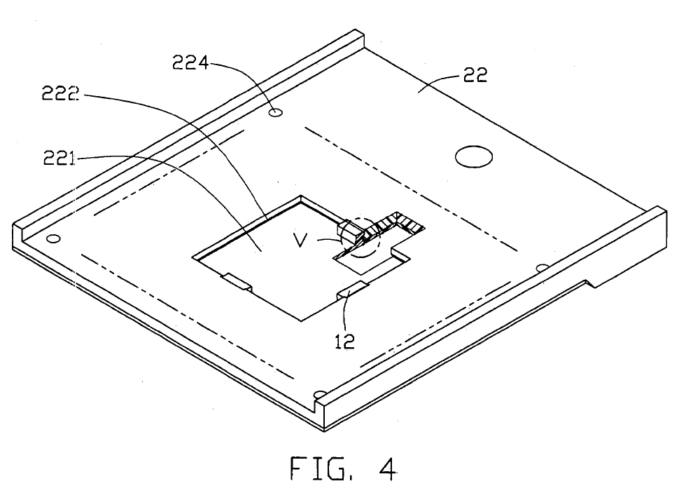

The CPU socket 2 has an insulative housing 21 receiving a plurality of conducive contacts (not shown) therein for soldering to the printed circuit board, and a cover 22 slidably mounted on the housing 21. Further referring to FIG. 4, the cover 22 defines a central square-shaped opening 221 surrounded by four inner side edges 222. An array of pin holes 224 is defined around the square opening 221, for insertion therethrough of corresponding pins of the CPU (not shown). Four recesses 223 are defined at junctions of a bottom face of the cover 22 and the four side edges 222 respectively.

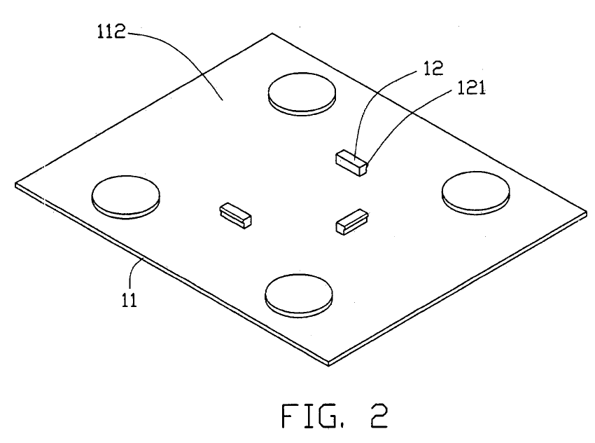

Referring to FIGS. 1 and 2, the pick up cap 1 includes a flat base 11. The base 11 defines a smooth and integral top surface 111, and an opposite bottom surface 112. Four blocks 12 are formed on the bottom surface 112, corresponding to the recesses 223 of the cover 22. Each block 12 forms a latch protrusion 121 at a longitudinal edge thereof distal from the bottom surface 112.

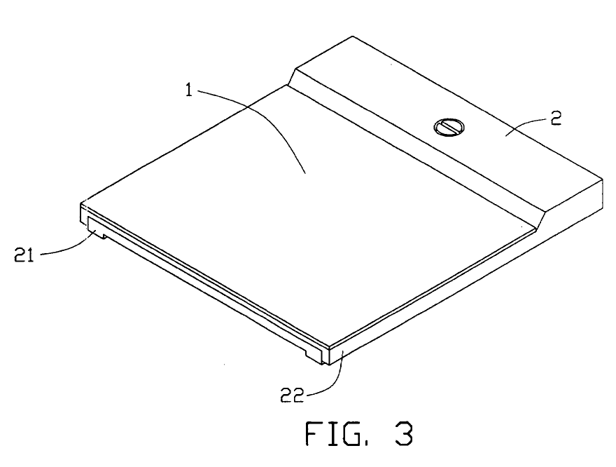

Referring to FIGS. 3 and 4, in assembly, the pick up cap 1 is vertically inserted onto the cover 22. The latch protrusions 121 of the pick up cap 1 engage in the recesses 223 of the inner side edges 222 of the cover 22. The blocks 12 abut against the inner side edges 222. Thus a CPU socket assembly is obtained, as shown in FIG. 3. The pick up cap 1 is securely fastened on the cover 22 of the CPU socket 2 by said engagement of the latch protrusions 121.

The top surface 111 of the pick up cap 1 is smooth and integral, thus enabling the pick up cap 1 to be reliably sucked by a vacuum nozzle (not shown) without air leakage during processing. In molding of the pick up cap 1, the latching blocks 12 of the pick up cap 1 can be easily formed by a mold having active mold pins that can be removed without disturbing the latch protrusions 121 of the blocks 12. That is, the latching blocks 12 of the pick up cap 1 can be formed without the need for any specialized molding pins that would otherwise create unwanted slots in the pick up cap 1.

While a preferred embodiment in accordance with the present invention has been shown and described, equivalent modifications and changes known to persons skilled in the art according to the spirit of the present invention are considered within the scope of the present invention as defined in the appended claims.

We claim:

1. A central processing unit (CPU) socket assembly for being moved for assembly onto a printed circuit board by a vacuum suction device, comprising:
a CPU socket having a cover, the cover defining a central opening and at least one recess adjacent and in communication with the central opening; and
a pick up cap removably assembled with the cover, the pick up cap defining a top surface and a bottom surface, at least one block being formed on the bottom surface of the pick up cap for engaging in the at least one recess;
wherein the top surface of the pick up cap is uniformly smooth and integral.

2. The CPU socket assembly as claimed in claim 1, wherein a latch protrusion is formed at a distal end of the block.

3. The CPU socket assembly as claimed in claim 2, wherein the at least one recess is defined at a bottom surface of the cover at the central opening.

4. The CPU socket assembly as claimed in claim 1, wherein the cover defines four recesses, and four blocks are formed on the bottom surface of the pick up cap.

5. The CPU socket assembly as claimed in claim 1, wherein the central opening is rectangular.

6. A central processing unit (CPU) socket assembly, comprising:
a CPU socket defining a central opening; and
a pick up cap including a flat base, the base defining a top surface and a bottom surface, at least one block being provided on the bottom surface, the at least one block engaging in the central opening of the CPU socket;
wherein the top surface of the pick up cap is unblemishedly smooth and integral so that a vacuum suction device can reliably suck the top surface of the pick up cap without air leakage.

7. The CPU socket assembly as claimed in claim 6, wherein the central opening is rectangular.

8. The CPU socket assembly as claimed in claim 6, wherein the CPU socket includes a cover, and the central opening is defined in the cover.

9. The CPU socket assembly as claimed in claim 8, wherein at least one recess is defined in a junction of a bottom face and an inside edge of the cover at the central opening.

10. The CPU socket assembly as claimed in claim 9, wherein the at least one block forms a latch protrusion at a distal end thereof, and the latch protrusion engaging in the at least one recess of the cover.

11. A pick and place cap for removable attachment to an electronic part so as to provide an assembly that can be picked up and placed by a machine, said electronic part having internal edge portions, the pick and place cap comprising:
a base having a uniformly smooth and integral surface for engagement with the machine; and
at least one block formed on another surface of the base for removable engagement with the edge portions of the electronic part.

12. The pick and place cap as claimed in claim 1, wherein the electronic part is a central processing unit (CPU) socket having a base and a cover slidably mounted on the base.

13. The pick and place cap as claimed in claim 12, wherein the cover defines a square opening.

14. The pick and place cap as claimed in claim 13, wherein at least one recess is defined in a bottom face of at least one of the edge portions of the cover at the square opening.

15. The pick and place cap as claimed in claim 14, wherein the at least one block forms a latch protrusion at a distal end thereof, and the latch protrusion engages in the at least one recess of the cover.

16. An electronic assembly comprising:
a socket defining a rectangular contact region with thereof lengthwise and lateral directions perpendicular to each other;
an opening defined in a center portion of said contact region, an exterior contour of said socket being much larger than said opening, said opening defining a plurality of boundary sides thereof;
at least two recesses formed in at least two of said boundary sides, respectively; and
a pick up cap including a planar base defining thereon opposite top and bottom surfaces with a pair of blocks downwardly extending from said bottom surface and respectively latchably engaged within the corresponding recesses; wherein
said blocks are somewhat deflectable so as to allow the cap to be downwardly attachably seated unto the top surface of the base.

17. The assembly as claimed in claim 16, wherein said pair of blocks are opposite to each other.

18. The assembly as claimed in claim 16, wherein there are three blocks extending from the bottom surface and respectively received in three recesses formed in three boundary sides of the opening.

19. The assembly as claimed in claim 16, wherein said cap fully covers said opening and provides a complete smooth plane above said opening without blemish.

20. The assembly as claimed in claim 16, wherein said cap is much larger than the opening in either the lengthwise direction or the lateral direction.
